(19) United States
(12) Patent Application Publication
(10) Pub. No.: US 2014/0182292 A1
(43) Pub. Date: Jul. 3, 2014

(54) INTEGRAL INSTRUMENTATION IN ADDITIVELY MANUFACTURED COMPONENTS OF GAS TURBINE ENGINES

(71) Applicant: UNITED TECHNOLOGIES CORPORATION, Hartford, CT (US)

(72) Inventors: David J. Hudon, North Berwick, ME (US); Steven D. Roberts, Moodus, CT (US); Gary A. Schirtzinger, Glastonbury, CT (US); Joe Ott, Enfield, CT (US)

(73) Assignee: UNITED TECHNOLOGIES CORPORATION, Hartford, CT (US)

(21) Appl. No.: 13/730,905

(22) Filed: Dec. 29, 2012

(51) Int. Cl. F02C 7/00

(52) U.S. Cl. CPC F02C 7/00
USPC 60/722; 29/592

(57) ABSTRACT

An article includes a body portion made of a metal and configured for use in a gas turbine engine, a sensing feature monolithically formed with the body portion, and an interior passage connected to the sensing feature and passing through the body portion. An article with integrated sensing features may be made additive manufacturing, resulting in a structure having internal passageways connecting an aperture at one surface of the monolithic article to a second aperture at another surface of the monolithic article at the opposite end of the internal passageway.

### STATEMENT OF GOVERNMENT INTEREST

The U.S. Government has a paid-up license in this invention and the right in limited circumstances to require the patent owner to license others on reasonable terms as provided for by the terms of Contract No. N00019-11-D-0003 awarded by the United States Navy.

### BACKGROUND

The described subject matter relates to turbine engines, and more particularly, to sensing instrumentation for use in turbine engines.

Gas turbine engines require measurements of operational conditions such as temperature and pressure. Often, the pressure and/or temperature of interest are those within a core airflow, such as in a compressor section. To accomplish these measurements, sensing heads of what are known as “kiel ports” or “kiels” have been attached to compressor vanes, for example by welding or brazing. Kiels transmit desired quantities of core air to external sensors. Kiels and associated tubing impinge or obstruct the core airflow.

### SUMMARY

A monolithic article including a body portion is made of metal and has a sensing feature. The sensing feature has an interior passage connected to it that passes through the body portion of the monolithic article. The monolithic article is configured for use in a gas turbine engine.

### BRIEF DESCRIPTION OF THE DRAWINGS

FIG. 1 schematically illustrates an example gas turbine engine.

FIG. 2 schematically illustrates a compressor section of a gas turbine engine.

FIG. 3 is a perspective view of a stator vane with four kiel receptacles, showing internal passages.

FIG. 4 is a perspective view of a kiel brazed into a kiel receptacle in a stator vane and attached to an internal passage.

FIG. 5 is a perspective view of a stator vane with four pressure taps, showing internal passages.

### DETAILED DESCRIPTION

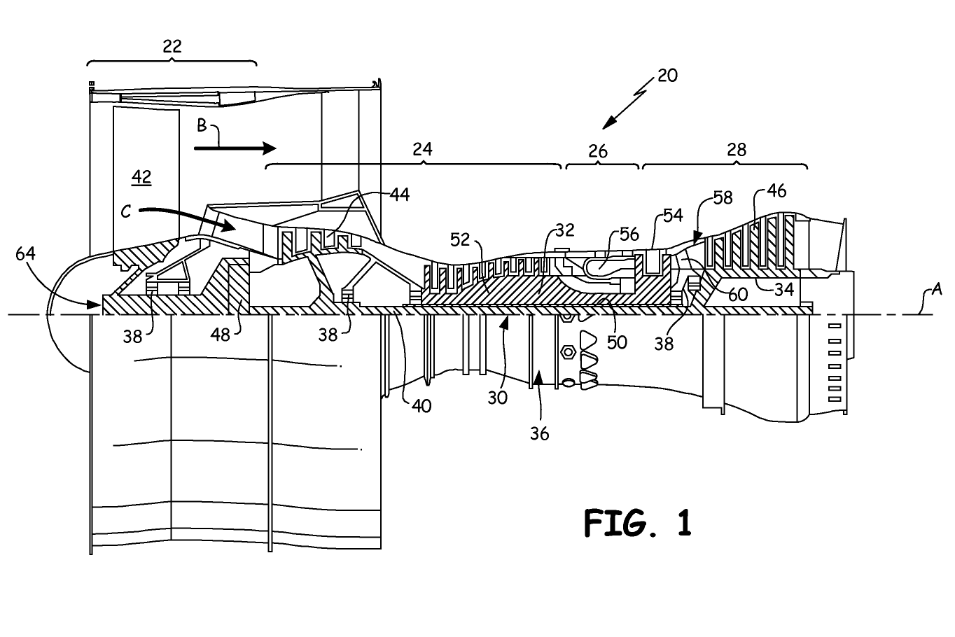

FIG. 1 schematically illustrates an example gas turbine engine 20 that includes fan section 22, compressor section 24, combustor section 26 and turbine section 28. Alternative engines might include an augmenter section (not shown) among other systems or features. Fan section 22 drives air along bypass flow path B while compressor section 24 draws air in along core flow path C where air is compressed and communicated to combustor section 26. In combustor section 26, air is mixed with fuel and ignited to generate a high pressure exhaust gas stream that expands through turbine section 28 where energy is extracted and utilized to drive fan section 22 and compressor section 24.

Although the disclosed non-limiting embodiment depicts a turbofan gas turbine engine, it should be understood that the concepts described herein are not limited to use with turbofans as the teachings may be applied to other types of turbine engines; for example a turbine engine including a three-spool architecture in which three spools concentrically rotate about a common axis, and where a low spool enables a low pressure turbine to drive a fan directly, or via a gearbox, an intermediate spool that enables an intermediate pressure turbine to drive an intermediate compressor of the compressor section, and a high spool that enables a high pressure turbine to drive a high pressure compressor of the compressor section.

Engine 20 generally includes low speed spool 30 and high speed spool 32 mounted for rotation about an engine central longitudinal axis A relative to an engine static structure 36 via several bearing systems 38. Bearing systems 38 can each include one or more journal bearings with a coated lubricant surface. It should be understood that various bearing systems 38 at various locations may alternatively or additionally be provided.

Low speed spool 30 generally includes inner shaft 40 that connects fan 42 and low pressure (or first) compressor section 44 to low pressure (or first) turbine section 46. Inner shaft 40 drives fan 42 directly, or through a speed change device, such as geared architecture 48, to drive fan 42 (via fan shaft 64) at a lower speed than low speed spool 30. High-speed spool 32 includes outer shaft 50 that interconnects high pressure (or second) compressor section 52 and high pressure (or second) turbine section 54. Inner shaft 40 and outer shaft 50 are concentric and rotate via bearing systems 38 about engine central longitudinal axis A.

Combustor 56 is arranged between high pressure compressor 52 and high pressure turbine 54. In one example, high pressure turbine 54 includes at least two stages to provide a double stage high pressure turbine 54. In another example, high pressure turbine 54 includes only a single stage. As used herein, a “high pressure” compressor or turbine experiences a higher pressure than a corresponding “low pressure” compressor or turbine.

The example low pressure turbine 46 has a pressure ratio that is greater than about 5. The pressure ratio of the example low pressure turbine 46 is measured prior to an inlet of low pressure turbine 46 as related to the pressure measured at the outlet of low pressure turbine 46 prior to an exhaust nozzle.

Mid-turbine frame 58 of engine static structure 36 is arranged generally between high pressure turbine 54 and low pressure turbine 46. Mid-turbine frame 58 further supports bearing systems 38 in turbine section 28 as well as setting airflow entering low pressure turbine 46.

The core airflow C is compressed by low pressure compressor 44 then by high pressure compressor 52 mixed with fuel and ignited in combustor 56 to produce high speed exhaust gases that are then expanded through high pressure turbine 54 and low pressure turbine 46. Mid-turbine frame 58 includes vanes 60, which are in the core airflow path and function as an inlet guide vane for low pressure turbine 46. Utilizing vane 60 of mid-turbine frame 58 as the inlet guide vane for low pressure turbine 46 decreases the length of low pressure turbine 46 without increasing the axial length of mid-turbine frame 58. Reducing or eliminating the number of vanes in low pressure turbine 46 shortens the axial length of turbine section 28. Thus, the compactness of gas turbine engine 20 is increased and a higher power density may be achieved.

The disclosed gas turbine engine 20 in one example is a high-bypass geared aircraft engine. In a further example, gas turbine engine 20 includes a bypass ratio greater than about six (6), with an example embodiment being greater than about ten (10). The example geared architecture 48 is an epicyclical gear train, such as a planetary gear system, star gear system or other known gear system, with a gear reduction ratio of greater than about 2.3. An example epicyclical gear train with journal bearings is shown in subsequent figures.

In one disclosed embodiment, gas turbine engine 20 includes a bypass ratio greater than about ten (10:1) and the fan diameter is significantly larger than an outer diameter of low pressure compressor 44. It should be understood, however, that the above parameters are only exemplary of one embodiment of a gas turbine engine including a geared architecture and that the present disclosure is applicable to other gas turbine engines.

A significant amount of thrust is provided by bypass flow B due to the high bypass ratio. Fan section 22 of engine 20 is designed for a particular flight condition—typically cruise at about 0.8 Mach and about 35,000 feet. The flight condition of 0.8 Mach and 35,000 ft., with the engine at its best fuel consumption—also known as “bucket cruise Thrust Specific Fuel Consumption (‘TSFC’)”—is an industry standard parameter of pound-mass (lbₘ) of fuel per hour being burned divided by pound-force (lb_{f}) of thrust the engine produces at that minimum point.

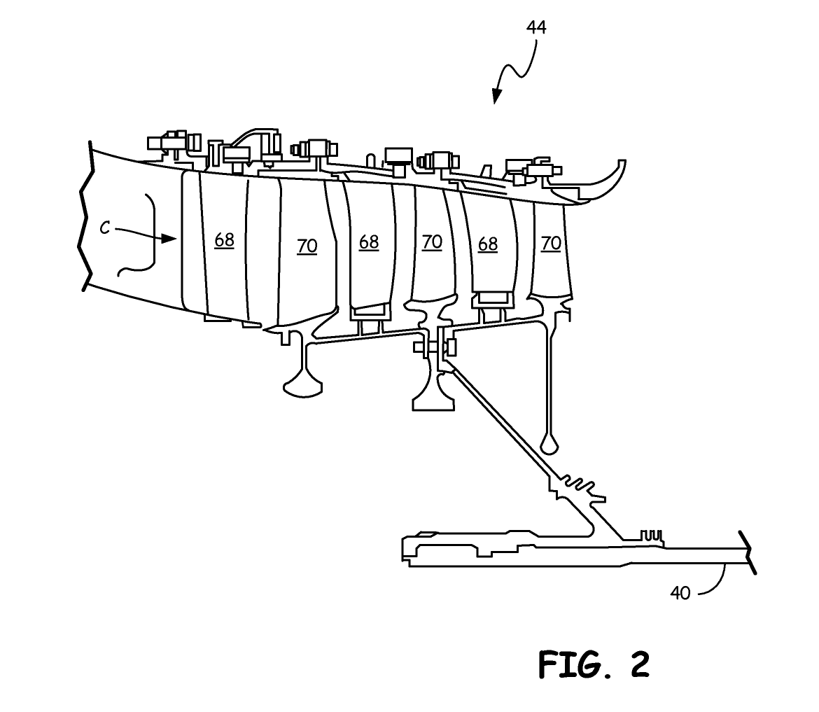

FIG. 2 is a schematic of low pressure compressor 44. FIG. 2 shows core flow C, inner shaft 40, compressor vanes 68, and compressor blades 70. Core flow C passes between interdigitated compressor vanes 68 and compressor blades 70. Compressor blades 70 are connected to inner shaft 40, such that rotation of inner shaft 40 causes rotation of compressor blades 70. Compressor vanes 68 are attached to a non-rotating portion of low pressure compressor 44 of gas turbine engine 20. Rotation of inner shaft 40 and compressor blades 70 results in compression of core flow C as it travels from left to right.

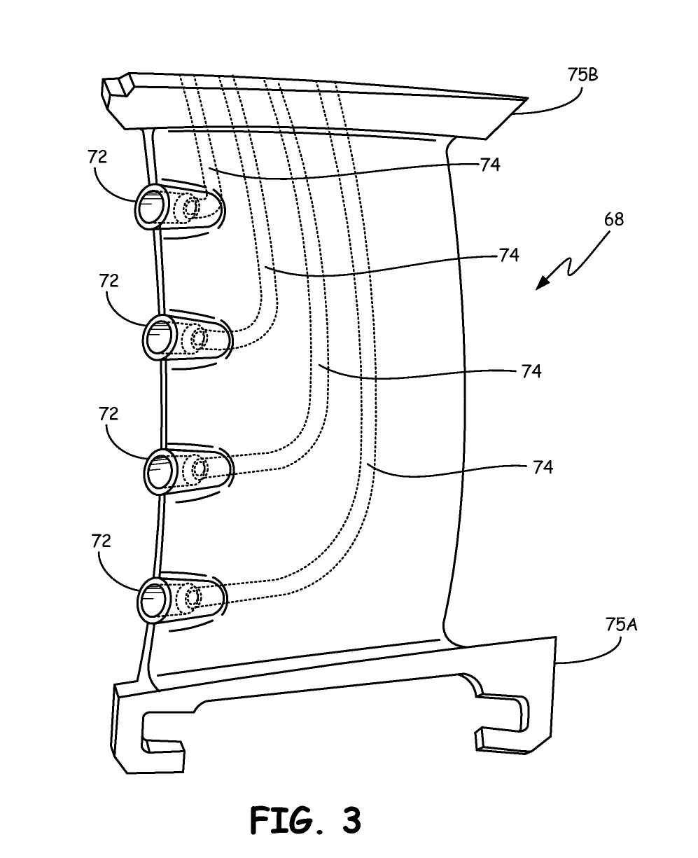

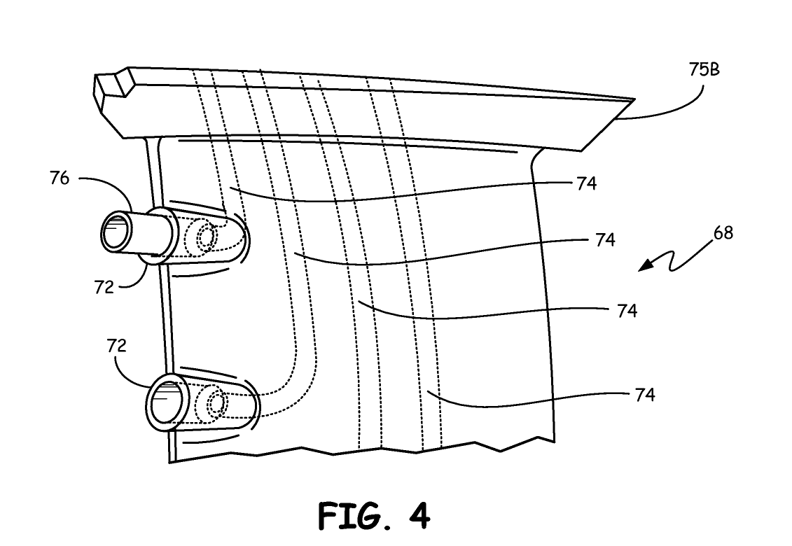

Low pressure compressor 44 is designed to have a pressure and temperature gradient, both of which increase as core flow C passes from the left to right sides of FIG. 2. Deviations from these specifications can cause inefficiency, or even failure, of the engine. Thus, kiel receptacles 72 (FIGS. 3-4) and kiels 76 (FIG. 4) are often attached to compressor vanes 68.

FIG. 3 is a perspective view of compressor vane 68, including kiel receptacles 72, sensor tubing 74, radially inner platform 75A, and radially outer platform 75B. Compressor vane 68 is made using an additive manufacturing process. Additive manufacturing processes are known, and include many techniques. For example, additive manufacturing processes such as stereolithography, direct metal laser sintering, selective laser sintering, e-beam melting, and e-beam wire may be used to create compressor vane 68. Using additive manufacturing, kiel receptacle 72, sensor tubing 74, inner platform 75A and outer platform 75B may be built into compressor vane 68 in a monolithic structure.

Radially inner platform 75A and radially outer platform 75B are positioned at the radially inner and outer portions of compressor vane 68, respectively. Radially inner platform 75A and radially outer platform 75B attach compressor vane 68 to a non-rotating portion of gas turbine engine 20, as shown in FIG. 2. Adjacent components within low pressure compressor 44 (FIG. 2) may include sensors, or may include additional routing or tubing to direct sampled air from sensor tubing 74 towards sensors.

Sensor tubing 74 connects kiel receptacle 72 to sensors (not shown). Examples of potential sensors include temperature sensors or pressure sensors. Often, sensors are too large or sensitive to be positioned within core flow C (FIGS. 1-2). Thus, it is necessary to transport sampled working fluid from within core flow C (FIGS. 1-2) to external sensors. Sensor tubing 74 is in fluid communication with kiel receptacles 72, such that working fluid adjacent to kiel receptacles 72 may circulate through sensor tubing 74. Sensor tubing 74 is routed through compressor vane 68 and radially outer platform 75B on a path toward sensors (not shown). In alternative embodiments, sensor tubing 74 may be routed through radially inner platform 75A.

Kiel receptacles 72 may be fitted with kielheads 76, as shown in FIG. 4. Kiel receptacles 72 are used to gather data on core flow C (FIGS. 1-2). Typically, air is allowed to flow through kiel receptacles 72, through sensor tubing 74, to a sensor outside of core flow C.

By forming kiel receptacles 72 and sensor tubing 74 integrally with compressor vane 68, the flowpath of core flow C (FIGS. 1-2) is impinged to a lesser extent than if the same components were separately formed, then affixed to the vane. Kiel receptacles 72 allow for sensing of pressure or temperature of core flow C (FIGS. 1-2). Kiel receptacles 72 may be formed on the leading edge of compressor vane 68, as shown, or they may be formed on other fixed parts within a gas turbine engine. For example, kiel receptacles 72 may be formed in stator blades in the high pressure compressor portion of compressor section 24, or they may be located in combustor section 56, or turbine section 28.

Kiel receptacles 72 or other devices for measuring characteristics of core air flow C (FIG. 1) may be incorporated on nearly any body portion of gas turbine engine 20 (FIG. 1). Any non-rotating body portion may be used as a surrounding structure for the sensing devices.

FIG. 4 shows a portion of stator vane 68, including kielhead 76. Stator vane 68 includes kiel receptacle 72, sensor tubing 74, and radially outer platform 75B. As described with respect to FIG. 3, kiel receptacle 72, sensor tubing 74, and radially outer platform 75B are formed integrally with compressor vane 68 to reduce protrusions of kiel receptacle 72 or sensor tubing 74 into core flow C (FIGS. 1-2). Kielhead 76 may also be monolithically formed using additive manufacturing, or it may be manufactured separately and attached to kiel receptacle 72, for example by brazing. Sampled working fluid incident at kielhead 76 is directed towards a sensor (not shown) through sensor tubing 74, which is routed through stator vane 68, including radially outer platform 75B.

Kielhead 76 may have different dimensions and geometries based on the specifics of the engine which it is incorporated into and which parameters are sensed. Brazing kielhead 76 into stator vane 68 may allow for greater freedom in choosing which kielhead design to use. Alternatively, forming kielhead 76 monolithically with stator vane 68 facilitates advantages in reduced space and complexity of design.

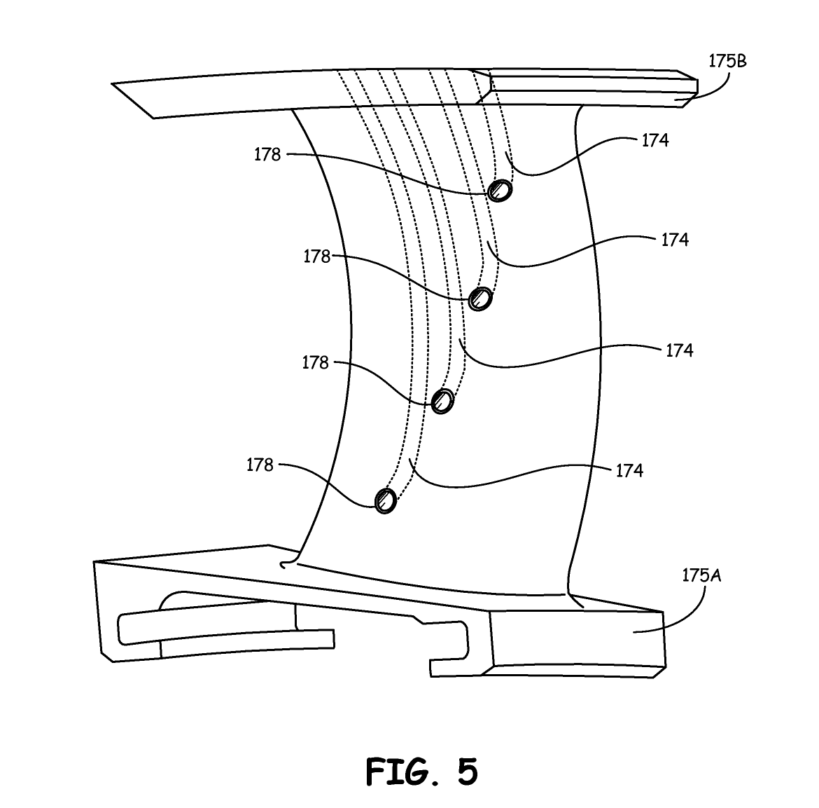

FIG. 5 shows stator vane 168, including sensor tubings 174, apertures 178, radially inner platform 175A and radially outer platform 175B. Stator vane 168 incorporates sensor tubing 174 and apertures 178 in order to facilitate measurement of parameters such as temperature or pressure along the suction side of stator vane 168.

As described with respect to FIGS. 3-4, sensor tubings 174 are integrally formed passages through stator vane 168. In the embodiment shown in FIG. 5, sensor tubings 174 terminate along the suction side of stator vane 168. Apertures 178 are formed in the surface of stator vane 168 at the termini of sensor tubings 174 in order to allow sampling of fluid along the suction side of stator vane 168. Sampled working fluid is routed through sensor tubings 174 through stator vane 168, including radially outer platform 175B, en route to external sensors. Pressures and temperatures at apertures 178 affect temperatures and pressures in sensor tubings 174, which are detected by temperature and pressure sensors (not shown).

Apertures 178 and sensor tubings 174 are formed integrally with stator vane 168, such that there is no impingement of core flow C (FIGS. 1-2) due to protruding tubing or sensor heads. Those skilled in the art will recognize that apertures 178 and sensor tubings 174 may be incorporated in various other location on stator vane 168, or on various other stationary parts throughout gas turbine engine 20 (FIG. 1).

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

### DISCUSSION OF POSSIBLE EMBODIMENTS

The following are non-exclusive descriptions of possible embodiments of the present disclosure.

An article includes a body portion made of a metal and configured for use in a gas turbine engine, a sensing feature monolithically formed with the body portion, and an interior passage operatively connected to the sensing feature and passing through the body portion.

The sensing feature may be a kiel receptacle or a kiel, and the body portion may be a compressor stator having a pressure side, a suction side that intersects the pressure side at an upstream end and at a downstream end, an upstream blade edge where the pressure side and the suction side meet at the upstream end, and a downstream blade edge where the pressure side and the suction side meet at the downstream end.

The interior passage may pass between the suction side and the pressure side. The body portion may include a radially inner platform and a radially outer platform. The interior passage may pass through at least one of the radially inner platform and the radially outer platform. The sensing feature may be formed on the upstream blade edge, the pressure side, or the suction side. The sensing feature may be a pressure or temperature sensor.

A method for making a monolithic article includes additively manufacturing the monolithic article, the article comprising an internal passageway having a first end and a second end, a first aperture arranged along a first surface of the monolithic article at the first end of the internal passageway, and a second aperture arranged along a second surface of the monolithic article at the second end of the internal passageway.

Additively manufacturing the monolithic article may include manufacturing the article using direct metal laser sintering. The monolithic article may be a compressor vane, and the compressor vane may include a leading edge, a trailing edge, a suction side, and a pressure side. The first aperture may be located on the pressure side.

Forming the monolithic article may include forming a kiel receptacle integrally on the leading edge and adjacent to the first aperture, and may also include brazing a kiel into the kiel receptacle. The method may also include forming the monolithic article by forming a kiel head integrally with the monolithic article adjacent to the kiel receptacle.

1. An article comprising:
a body portion made of a metal and configured for use in a gas turbine engine;
a sensing feature monolithically formed with the body portion; and
an interior passage operatively connected to the sensing feature and passing through the body portion.

2. The article of claim 1, wherein the sensing feature is a kiel receptacle.

3. The article of claim 1, wherein the sensing feature is a kiel.

4. The article of claim 1, wherein body portion is a compressor stator including:
a pressure side;
a suction side that intersects the pressure side at an upstream end and at a downstream end;
an upstream blade edge where the pressure side and the suction side meet at the upstream end; and
a downstream blade edge where the pressure side and the suction side meet at the downstream end.

5. The article of claim 4, wherein the interior passage passes between the suction side and the pressure side.

6. The article of claim 4, and the body portion further comprising:
a radially inner platform; and
a radially outer platform.

7. The article of claim 6, wherein the interior passage passes through at least one of the radially inner platform and the radially outer platform.

8. The article of claim 4, wherein the sensing feature is formed on the upstream blade edge.

9. The article of claim 4, wherein the sensing feature is formed on the pressure side.

10. The article of claim 4, wherein the sensing feature is formed on the suction side.

11. The article of claim 1, wherein the sensing feature is a pressure sensor.

12. The article of claim 1, wherein the sensing feature is a temperature sensor.

13. A method of making a monolithic article, comprising:
additively manufacturing the monolithic article, the article comprising:
an internal passageway having a first end and a second end;
a first aperture arranged along a first surface of the monolithic article at the first end of the internal passageway; and
a second aperture arranged along a second surface of the monolithic article at the second end of the internal passageway.

14. The method of claim 13, wherein additively manufacturing the monolithic article includes manufacturing the article using direct metal laser sintering.

15. The method of claim 13, wherein the monolithic article is a compressor vane.

16. The method of claim 13, wherein the compressor vane comprises a leading edge, a trailing edge, a suction side, and a pressure side.

17. The method of claim 16, wherein the first aperture is located on the pressure side.

18. The method of claim 16, wherein forming the monolithic article includes forming a kiel receptacle integrally on the leading edge and adjacent to the first aperture.

19. The method of claim 18, and further comprising brazing a kiel into the kiel receptacle.

20. The method of claim 18, wherein forming the monolithic article includes forming a kiel head integrally with the monolithic article adjacent to the kiel receptacle.
